(19) United States
(12) Patent Application Publication
(10) Pub. No.: US 2014/0310711 A1
(43) Pub. Date: Oct. 16, 2014

(54) METHOD FOR DETERMINING PERFORMANCE OF PROCESS OF APPLICATION AND COMPUTER SYSTEM

(71) Applicant: TENCENT TECHNOLOGY (SHENZHEN) COMPANY LIMITED, Shenzhen (CN)

(72) Inventors: Tingli Bi, Shenzhen (CN); Kefeng Nie, Shenzhen (CN)

(73) Assignee: TENCENT TECHNOLOGY (SHENZHEN) COMPANY LIMITED, Shenzhen (CN)

(21) Appl. No.: 14/294,399

(22) Filed: Jun. 3, 2014

Related U.S. Application Data
(63) Continuation of application No. PCT/CN14/70763, filed on Jan. 17, 2014.

(30) Foreign Application Priority Data
Apr. 11, 2013 (CN) 201310124995.8

(51) Int. Cl. G06F 11/34

(52) U.S. Cl. CPC G06F 11/3409
USPC 718/100

(57) ABSTRACT

A method and a computer system for determining performance of a process of an application are provided for application in the field of computer technology. When the process of the application is started, an apparatus for determining the performance of a startup procedure of the process acquires a process startup beginning time and determines a time of when the process is ready or able to respond to user input. The time of when the process of the application is ready or able to respond to user input may be used as the process startup ending time. A startup period for the process of the application is determined. Performance of the startup procedure of the process of the application is determined based on the process startup beginning time and the process startup ending time as the time the process of the application is ready or able to respond to user input.

This application is a continuation application of International Application PCT/CN2014/070763, filed on Jan. 17, 2014, which claims the priority to Chinese Patent Application No. 201310124995.8, filed on Apr. 11, 2013 in the Chinese Patent Office, entitled “METHOD FOR DETERMINING PERFORMANCE OF PROCESS OF APPLICATION AND COMPUTER SYSTEM,” both of which are incorporated herein by reference in their entireties.

### FIELD OF THE INVENTION

The present invention relates to the field of computer technology, and particularly to a method for determining a performance of a process of an application and a computer system.

### BACKGROUND OF THE INVENTION

Performance of a process of an application may be indicated by multiple types of parameters. Specifically, time consumption during a startup period of the process is an important performance measurement parameter. If the duration of the startup period may be determined accurately, startup performance of the process of the application may be indicated accurately.

### SUMMARY OF THE INVENTION

A method and a computer system for determining performance of a process of an application are provided according to several embodiments of the disclosure. More specifically, performance during a startup period of the process of the application may be determined accurately.

A method for determining performance of a process of an application is provided according to an embodiment of the disclosure. The method may include:

acquiring a process startup beginning time for the process of the application when the process of the application is started;

determining a time of when the process of the application is able to respond to a user input and utilizing the time of when the process is able to respond to the user input as a process startup ending time for the process of the application; and

determining a process startup period for the process of the application based on the process startup beginning time and the time of when the process is able to respond to the user input as the process startup ending time, to determine startup performance for the process of the application.

A computer system for determining performance of a process of an application is provided according to an embodiment of the present disclosure, which may include:

a process startup unit adapted to start a process of an application;

a startup beginning time acquiring unit adapted to acquire a process startup beginning time of the application when the process of the application is started by the process startup unit;

a response time determining unit adapted to determine a time of when the process of the application is able to respond to user input and utilizing the time of when the process is able to respond to the user input as a process startup ending time for the process of the application; and

a performance determining unit adapted to determine a startup period of the application based on the process startup beginning time and the time of when the process is able to respond to the user input as the process startup ending time, to determine startup performance for the process of the application.

The performance of a process of an application or the startup performance may be referred to as a performance measurement.

In some embodiments of the present disclosure, when a process of an application is started, an apparatus for determining performance of the process of the application may acquire a process startup beginning time and may determine a time of when the process of the application is able to respond to a user input, and may use the time of when the process of the application is able to respond to the user input as a process startup ending time. A startup period for the process of the application may be determined based on the process startup beginning time and the process startup ending time, so as to determine a process startup performance measurement for the process of the application. Hence, even if processes of some applications do not utilize user interactive windows as their user interface, it may not prevent or hinder the calculating of the startup period of the process of the application. Therefore, the startup period of the process of the application may be obtained accurately, and the startup performance of the process of the application may be determined accurately.

### BRIEF DESCRIPTION OF THE DRAWINGS

The present disclosure may be better understood with reference to the following drawings and descriptions which include non-limiting and non-exhaustive embodiments of the disclosure. The drawings described hereinafter include only some embodiments related to the present disclosure. Other drawings may be determined by those skilled in the art based on these drawings, without any creative effort.

FIG. 1 is a flow chart of a method for determining performance of a process of an application according to an embodiment of the disclosure.

FIG. 2 is a flow chart of a method for determining performance of a process of an application according to an embodiment of the disclosure.

FIG. 3 is a flow chart of a method for determining a performance of a process of an application according to an embodiment of the disclosure.

FIG. 4 is a schematic structural diagram representing a computer system according to an embodiment of the disclosure.

FIG. 5 is a schematic structural diagram representing a computer system according to an embodiment of the disclosure.

FIG. 6 is a schematic structural diagram representing a computer system according to an embodiment of the disclosure.

FIG. 7 is a schematic structural diagram representing a terminal to which a method for determining performance of a process of an application may be applied according to an embodiment of the disclosure.

### DETAILED DESCRIPTION OF THE DISCLOSURE

The following embodiments of the present disclosure will be described in conjunction with the accompanying drawings. All other embodiments determined by those skilled in the art based on the embodiments of the present disclosure without any creative work will fall within the scope of protection of the present disclosure.

A method for determining performance of a process of an application is provided according to an embodiment of the present disclosure. The performance of the process of the application is determined mainly by determining a startup period of the process of the application. The method may be performed by an apparatus for determining the performance of the process of the application.

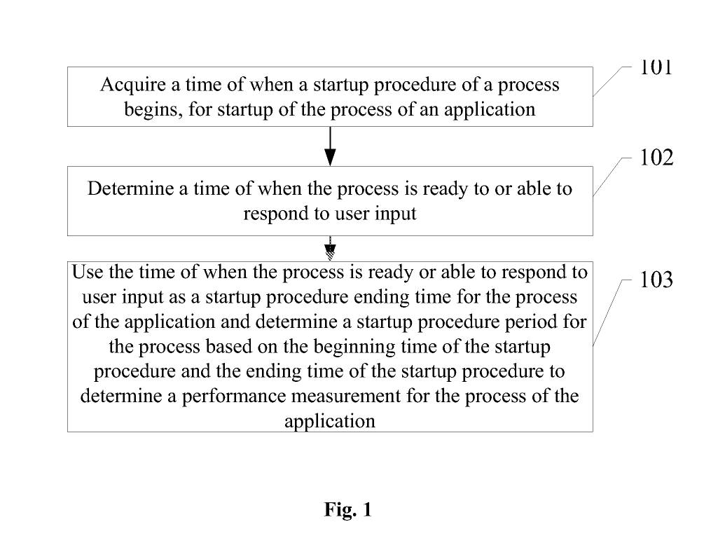

Now turning to the Figures. A flow chart is shown in FIG. 1 for determining performance of a process of an application according to an embodiment of the disclosure. The flow chart includes method steps 101-103.

Step 101, may include acquiring a process startup time t1 of an application when a process of the application is started.

An apparatus for determining performance of the process of the application may acquire multiple parameters of the process and may determine a startup procedure performance measurement for the process of the application. For example, a startup period for the process of the application may be determined or acquired and a performance measurement for startup of the process of the application may be determined based on the startup period. Thus, the apparatus for determining performance of a process of an application may first acquire the process startup beginning time for the application.

In some embodiments, the apparatus for determining the performance of the process of the application may first call an Application Programming Interface (API) of a CreateProcess to create the process of the application. For some processes of applications, for example, processes that cannot be created, the apparatus for determining the performance of the process of the application may prompt a user to start the application manually, such as by clicking an icon of the process of the application. The apparatus for determining the performance of the process of the application may call an API of a GetTickCount to acquire the process startup beginning time t1 of the process of the application.

Step 102, may include determining a time at which the process of the application is ready or able to respond to a user input, which may be used as a process startup procedure ending time t2 of the application. Some processes of applications may receive information input by a user and may perform a certain operations according to the information input by the user. In instances when the process of the application is able to respond to the user input, the process of the application may be able to receive information input by a user. For example, it may be determined whether the process of the application may receive a mouse input and/or a keyboard input and so on. Further, it may be determined whether the mouse input or the keyboard input may interrupt the process of the application. In instances when the mouse input or the keyboard input may interrupt the process of the application, the process of the application may be able to respond to the user input.

Step 103, may include determining a startup period of the process of the application based on the process startup beginning time t1 and the process startup ending time t2 and to determine a startup performance measurement of the process of the application. The startup period may be determined as a difference between the process startup ending time t2 and the process startup beginning time t1. In instances when the startup period of the application is long, the startup performance of the process of the application may be considered to be poor, and a further optimization may be performed.

A process of the application described herein may refer to an active application. The apparatus for determining the performance of the process of the application may have stored code of the application in a storage module. The process may be an application that occupies system resources. An application may be referred to as a “program” before being called into a memory space, and may be referred to as a “process” after being called into memory and/or when occupying resources. One process may include many threads. Code of each application may be stored in a space in a corresponding space segment of the storage module, and the process of the application may include multiple execution threads. The step of starting a process of an application may include: loading code and other information used in the execution of the process of the application into the storage module of the apparatus for determining the performance of the process of the application. In this case, the startup beginning time of the process of the application may be a time of starting the loading of the code and the other information, and the process startup ending time of the application may be a time of completing the loading of the code and other information. In some embodiments of the disclosure, the step of starting the process of the application may be referred to as a startup procedure or a process startup, for example.

In some embodiments of the present disclosure, when the process of the application is started, the apparatus for determining the performance of the process of the application may acquire the process startup beginning time of the process of the application, determine a time of when the process of the application can respond to user input, for example, when the application is ready or able to respond or about to respond. The time of when the process of the application can respond to the user input may be used as the process startup ending time of the process of the application. The startup period of the process of the application may be determined based on the process startup beginning time and the process startup ending time. In this way, a performance measurement of the startup of the process of the application may be determined. Therefore, even in instances when some processes of an application do not have user interactive interfaces, it may not affect determination of the startup period of the process of the application, thus the startup period of the process of the application may be obtained accurately, and the performance of the startup of the process of the application may be determined accurately.

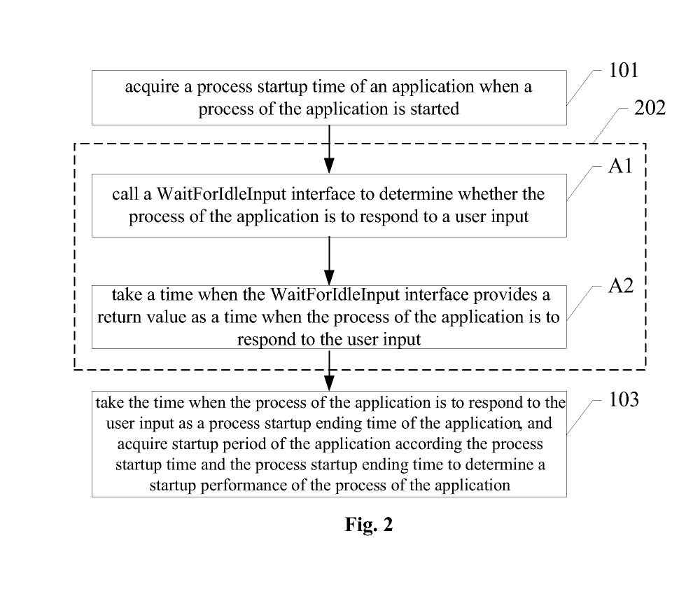

FIG. 2 is a flow chart of a method for determining a performance measurement for a process of an application according to an embodiment of the disclosure. FIG. 2 includes the steps 101, and 103 described with respect to FIG. 1. Step 202 illustrates method step that corresponds to step 102 for an application that may include a command line user interface (CUI) application, for example, an application for realizing a ping command In this case, a mouse input may not be supported and an instruction may be input by a user via a key board. The process of the application may execute the instruction. In this case, step 102 may be performed by an apparatus for determining the performance of the process of the application according to step 202 which may further include steps A1-A2.

Step A1 of step 202 may include: calling a WaitForIdleInput interface to determine whether the process of the application is able or ready to respond to user input. For example, in a case where the apparatus for determining the performance of the process of the application calls the WaitForIdleInput interface, the WaitForIdleInput interface may provide a return value when the process of the application has an idle and thus may be able or ready to process the user input. The WaitForIdleInput interface may not provide a return value while the process of the application does not have an idle and therefore, may not be able or ready to process the user input.

Step A2 of step 202 may include: acquiring a time of when the WaitForIdleInput interface provides a return value and utilizing the time of when the WaitForIdleInput interface provides the return value as a time of when the process of the application is able or ready to respond to the user input.

Further, when the WaitForIdleInput interface does not provide the return value within a preset first timeout period, the apparatus for determining the performance of the process of the application may stop performing the step 202 or step 102 described above with respect to FIG. 1. For example, the apparatus for determining the performance of the process of the application may stop the step of determining a time when the process of the application is able or ready to respond to the user input. In some embodiments, during a startup procedure of the process of the application, if the process of the application cannot respond to user input for some reason, for example, execution threads may be in an infinite loop, the apparatus for determining the performance of the process of the application may stop a procedure for acquiring the startup period of the process of the application. In this manner, the execution of the process of the application may not be affected by the operations for determining the performance of the process of the application. In some embodiments, since the startup procedure of the process of the CUI application may not be interrupted by other execution threads, it may be convenient to acquire the time of when the process of the application is ready or able to respond to the user input utilizing the WaitForIdleInput interface, and thus determine the startup period of the process of the application.

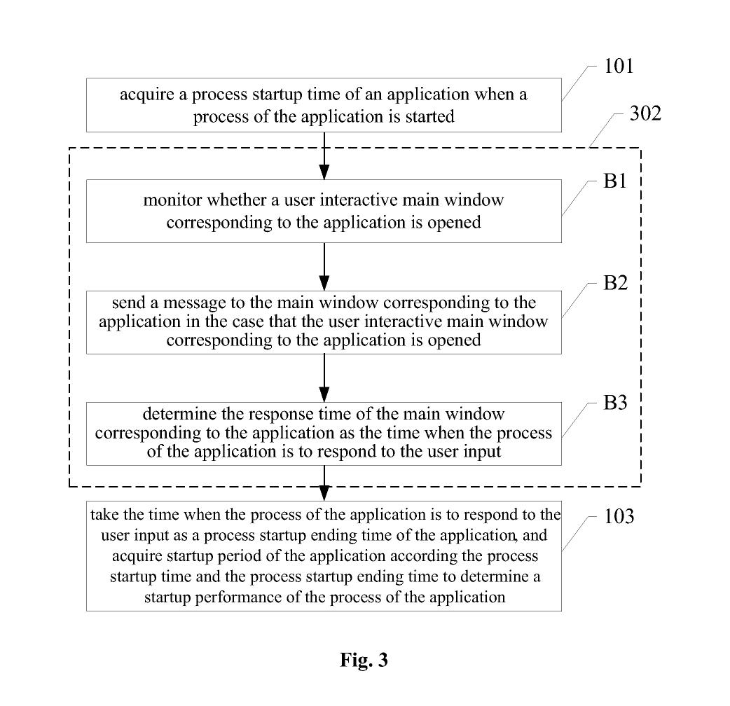

FIG. 3 is a flow chart of a method for determining a performance measurement for a process of an application according to an embodiment of the present disclosure. FIG. 3, may include steps 101 and 103 described with respect to FIG. 1. The method of FIG. 3 represents an embodiment where step 102 of FIG. 1 may include the steps B1-B3 of step 302. In this regard, an application may comprise a Graphical User Interface (GUI) application, for example, a resource manager. A startup procedure of a process of the application may not only include loading code and other information of the application, but may also display user interactive windows, for example, a main window and child windows, in a graphical manner. Therefore, there may be multiple execution threads in the startup procedure of the process of this type of application. The step 102 described with respect to FIG. 1, may be realized by the apparatus for determining the performance of the process of the application according to step 302 which may include steps B1-B3.

Step B1 may include: monitoring whether a user interactive main window corresponding to the application is open or displayed.

Step B2 may include: sending a message to the main window corresponding to the application, in a case that the user interactive main window corresponding to the application is open. The main window may be a window on top of the process of the application, and in some instances may be a window with the largest area. The user interactive main window may be referred to as the main window, for example.

The apparatus for determining the performance of the process of the application may call a message monitoring SetWindowsHookEx interface and an event monitoring SetWinEventHook interface to wait for a notification of a message or an event of the application. In a case where the apparatus for determining the performance of the process of the application calls the message monitoring interface, the message monitoring interface may selectively monitor displaying messages for a window corresponding to the application, and may also selectively monitor other messages. In instances when messages are detected by the message monitoring interface, it may be determined whether these messages are the displaying messages for the user interactive main window. In instances when these messages are the displaying messages of the user interactive main window, the main window corresponding to the application has been displayed. In a case where the apparatus for determining the performance of the process of the application calls the event monitoring interface, the event monitoring interface may monitor a displaying event of the user interactive main window corresponding to the application and may selectively monitor a displaying event of the user interactive main window corresponding to the application. When the displaying events are monitored, it may be determined whether these displaying events are displaying events of the user interactive main window. In instances when these displaying events are the displaying events of the user interactive main window, the main window corresponding to the application has been displayed.

When it is determined, based on the monitoring, that the main window corresponding to the application has been displayed, the apparatus for determining the performance of the process of the application may send a message to the main window. The message may be any suitable message. For example, the apparatus for determining the performance of the process of the application may send the message by calling a SendMessage interface. In instances when the main window responds to the message, it may mean or be an indication that the process of the application may also be ready or able to respond to user input. In this way, a response time of the main window may be utilized as a time when the process of the application is ready or able to respond to the user input.

Step B3 may include: determining the time of when the process of the application is ready or able to respond to the user input based on the time the response to the sent message, described above, is received from the displayed main window that corresponds to the application.

Furthermore, when the user interactive main window corresponding to the application does not respond to the message sent by the apparatus for determining the performance of the process of the application in step B2 within a preset second timeout, the apparatus for determining the performance of the process of the application may stop performing the step 302, and therefore, may stop determining the time of when the process of the application is to respond to the user input as described with respect to step 102. Hence, in the startup procedure of the process of the application, if the process of the application cannot respond to the user input, due to some reason, for example, execution threads may be in an endless loop, the apparatus for determining the performance of the process of the application will stop determining the startup period of the process of the application. In this manner, execution of the process of the application may not be affected.

Since the startup procedure of the process of the GUI application may include multiple execution threads, the user interactive main window corresponding to the application may not respond to user input within a time period after being displayed. In this instance, the process of the application may not have started completely or may not have completed the startup procedure. However, a time of when the main window is ready to respond to the user input after being displayed may be determined and utilized as the process startup ending time of the application. In this way, the startup period of the process of the application may be acquired accurately.

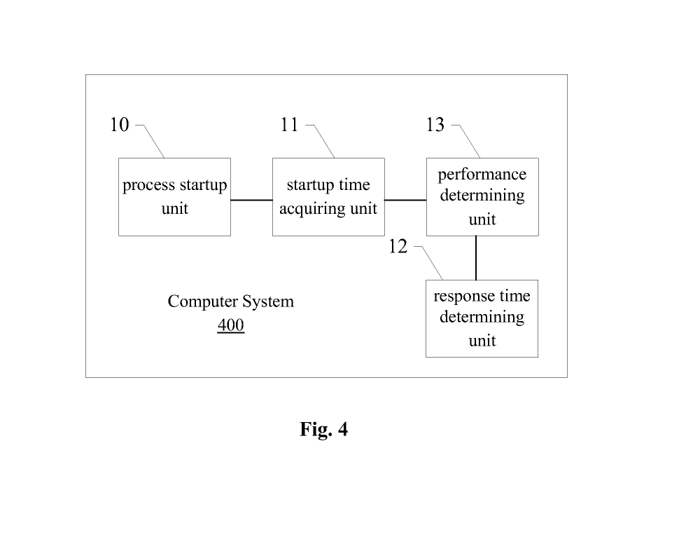

FIG. 4 is a schematic structural diagram of a computer system according to an embodiment of the disclosure. Referring to FIG. 4, there is shown a computer system 400 that may include a process startup unit 10, a startup time acquiring unit 11, a response time determining 12 and a performance determining unit 13.

In an embodiment of the present disclosure the computer system 400, may be referred to as an apparatus for determining the performance of the process of the application, which is described above with respect to FIGS. 1-3. Furthermore, a performance measurement for starting-up a process of an application may be determined by one or more units of the computer system 400 according to an embodiment of the method described with respect to FIGS. 1-3.

The process startup unit 10 may be adapted to start a process of an application.

The startup time acquiring unit 11 may be adapted to, when the process of the application is started by the process startup unit 10, acquire a process startup beginning time t1 for the process of the application. The startup time acquiring unit 11 may call an API for acquiring the process startup beginning time to acquire an indication of a time when the process of the application was started by the process startup unit 10.

The response time determining 12 may be adapted to determine a time of when the process of the application is ready or able to respond to user input and to utilize the time as a startup procedure ending time t2 for the process of the application.

The performance determining unit 13 may be adapted to determine a startup period that may be determined based on a difference between the process startup ending time t2 from the response time determining unit 12, and the process startup beginning time t1 from the startup time acquiring unit 10. In this manner, the performance determining unit 13 of the computer system 400 may be operable to determine a startup performance for the process of the application.

In operation, in the computer system 400 the startup time acquiring unit 11 may acquire a process startup beginning time for an application when the process startup unit 10 starts the process of the application. The response time determining unit 12 may determine a time of when the process of the application can respond to user input. The performance determining unit 13 may take the time of when the process of the application can respond to the user input as the process startup procedure ending time for the process of the application; and may determine a startup period for the application according the process startup beginning time and the process startup ending time to determine the startup performance of the process of the application. Therefore, even in cases where processes of applications do not have user interactive windows, there may not be any effect on the determination of the startup period of the process of the application. Thus, the startup period of the process of the application is acquired accurately, and the startup performance of the process of the application is determined accurately.

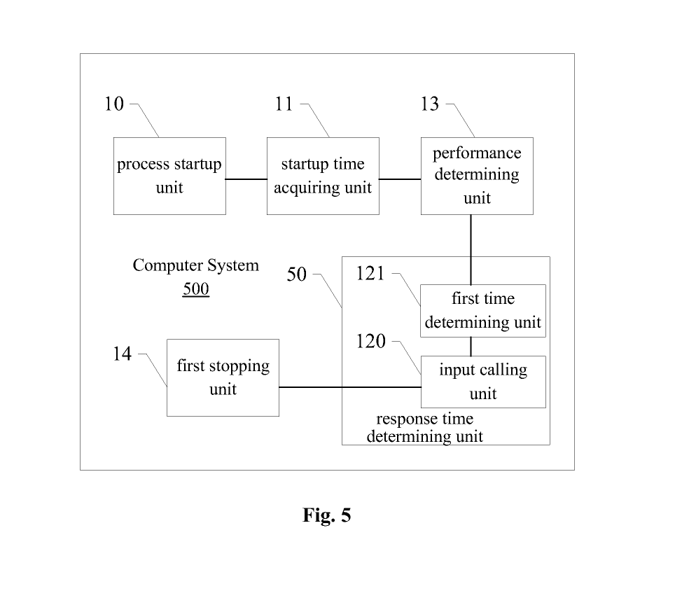

FIG. 5 is a schematic structural diagram representing a computer system according to an embodiment of the disclosure. Referring to FIG. 5, a computer system 500 may include the process startup unit 10, the startup time acquiring unit 11, the performance determining unit 13, a response time determining unit 50, a first time determining unit 121 and an input calling unit 120. The process startup unit 10, the startup time acquiring unit 11 and the performance determining unit 13 are described with respect to FIG. 4. In an embodiment of the disclosure for example, where an application is a CUI application, the computer system 500 may include a first stopping unit 14 in addition to the structure described with respect to FIG. 4. Moreover, the response time determining unit 50 of FIG. 5 may include an input calling unit 120 and a first time determining unit 121. The response time determining unit 50 may be operable to determine a time of when a process of an application can respond to user input. For example the time of when the process is ready or able to respond to input from a user.

The input calling unit 120 may be adapted to call a WaitForIdleInput interface to determine whether the process of an application started by the process startup unit 10 is ready or able to respond to user input.

The first time determining unit 121 may be adapted to receive a time indicating when the WaitForIdleInput interface called by the input calling unit 120 provides a return value which indicates that the process of the application has an idle. The time indicating when the WaitForIdleInput interface provided a return value may be used as the time when the process of the application can respond to the user input.

In instances when the WaitForIdleInput interface called by the input calling unit 120 does not provide the return value within a first timeout period, the first stopping unit 14 may notify the response time determining unit 50 to stop determining the time when the process of the application can respond to the user input.

In operation, the response time determining unit 50 may attempt to determine a time when a process of an application can respond to user input. In the computer system 500, the input calling unit 120 of the response time determining unit 50 may call a WaitForIdleInput interface. The first time determining unit 121 may determine a time of when the WaitForIdleInput interface provides a return value. The performance determining unit 13 may utilize the time determined by the first time determining unit 121 as a process startup ending time of the application. In instances when the WaitForIdleInput interface does not provide the return value within a preset first timeout, the first stopping unit 14 may notify the response time determining unit 50 to stop determining the time when the process of the application can respond to the user input.

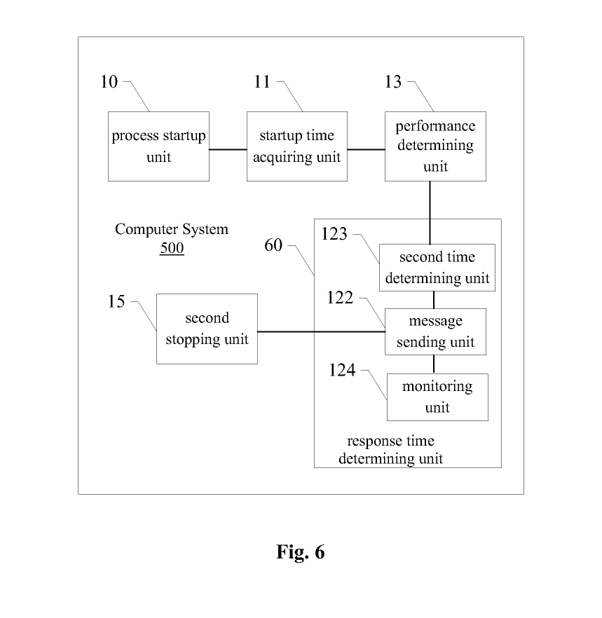

FIG. 6 is a schematic structural diagram representing a computer system according to an embodiment of the disclosure. Referring to FIG. 6, a computer system 600 may include the process startup unit 10, the startup time acquiring unit 11, the performance determining unit 13, a response time determining unit 60, a second time determining unit 123 a message sending unit 122, a monitoring unit 124 and a second stopping unit 15. The process startup unit 10, the startup time acquiring unit 11 and the performance determining unit 13 are described with respect to FIG. 4. In an embodiment of the disclosure, for example, in a case where the application is a GUI application, the computer system may include the second stopping unit 15 in addition to the structure described with respect to FIG. 4. Further, and the response time determining unit 60 may include the message sending unit 122, the second time determining unit 123 and the monitoring unit 124.

The monitoring unit 124 is adapted to monitor whether a user interactive main window that corresponds to the application is opened. Specifically, the monitoring unit 124 may call a message monitoring interface and an event monitoring interface to wait for a notification of a message or an event of the application. When the message monitoring interface or the event monitoring interface receives notification of a message or an event of the application, the monitoring unit 124 may determine whether the message or event is a displaying message or displaying event for the user interactive main window. In instances when the message or event is a displaying message or a displaying event for the user interactive main window, the monitoring unit 124 detects that the user interactive main window that corresponds to the application is open.

As described with respect to FIG. 4, the process startup unit 10 starts the process of the application. The message sending unit 122 may be adapted to send a message to the user interactive main window that corresponds to the application which was started by the process startup unit 10. The message may be sent when the monitoring unit 124 determines that the user interactive main window is opened.

The second time determining unit 123 may be adapted to determine a response time of when the user interactive main window responds to the message sent by the message sending unit 122, to be utilized as the time when the process of the application can respond to user input.

The second stopping unit 15 may adapted to, in instances when the user interactive main window does not respond to the message sent by the message sending unit 122 within a second timeout, stop the determining a time when the process of the application can respond to user input.

In operation, in the computer system 600, when the monitoring unit 124 determines that the user interactive main window that corresponds to the application is opened, the message sending unit 122 of the response time determining unit 60 may send a message to the user interactive main window and the main window may response to the message. The second time determining unit 123 may determine a response time for responding to the message from the open user interactive main window. The performance determining unit 13 may use the time determined by the second time determining unit 123 as the process startup procedure ending time of the application. In instances when the main window does not respond to the message within a first timeout period, the second stopping unit 15 may notify the response time determining unit 60 to stop the determining the time when the process of the application can respond to user input.

In the following example, the method for determining a performance measurement for a process of an application according to an embodiment of the disclosure may be applied to a terminal The terminal may be, for example, a smart phone, a panel computer, an ebook reader, a Moving Picture Experts Group Audio Layer III (MP3) player, a Moving Picture Experts Group Audio Layer IV (MP4) player, a laptop portable computer, a desktop computer and so on.

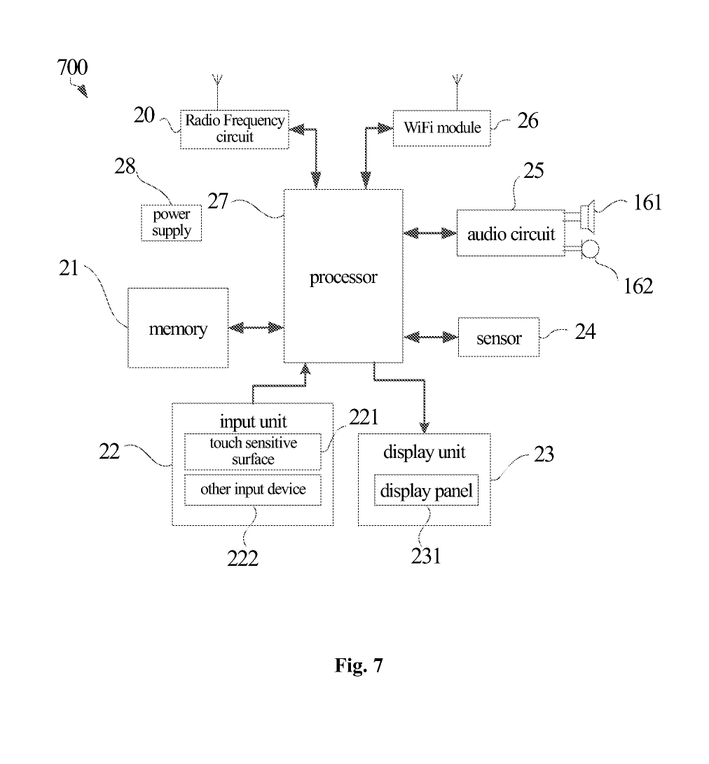

Reference is made to FIG. 7 which is a schematic structural diagram of a terminal 700 according to an embodiment of the disclosure.

The terminal 700 may include: a Radio Frequency (RF) circuit 20, a memory 21 including one or more non-transitory computer readable storage media, an input unit 22, a display unit 23, a sensor 24, an audio circuit 25, a wireless fidelity (WiFi) module 26, a processor 27 including one or more processing cores, a power supply 28 and so on. Those skilled in the art may understand that the terminal is not limited to the structure of the terminal shown in FIG. 7, and may include more components or less components than the illustrated components, a combination of the components, or a different arrangement of the components, for example.

The RF circuit 20 may be adapted to receive and send information, or receive or send a signal in a calling procedure. Specifically, the RF circuit 20 receives downlink information from a base station, and sends the information to one or more processors 27 to process. In addition, the RF circuit 20 sends uplink data to the base station. Normally, the RF circuit 20 includes but not limited to an antenna, at least one amplifier, a tuner, one or more oscillators, a Subscriber Identity Module (SIM) card, a transceiver, a coupler, a Low Noise Amplifier (LNA), a duplexer and so on. Furthermore, the RF circuit 20 may also communicate with a network or other devices via a wireless communication link. The wireless communication may be operated in any communication standard or protocol, which may include but is not limited to a Global System of Mobile communication (GSM), a General Packet Radio Service (GPRS), a Code Division Multiple Access (CDMA), a Wideband Code Division Multiple Access (WCDMA), a Long Term Evolution (LTE), an e-mail, a Short Messaging Service (SMS) and so on.

The memory 21 may be adapted to store software programs or modules, and the processor 27 may be adapted to perform various functions, applications and data processing by running the software programs or modules stored in the memory 21. The memory 21 may mainly include a program memory area and a data memory area. Specifically, the program memory area may store an operating system, an application utilized for at least one function (such as a sound playing function, an image playing function) and so on. The data memory area may store data (such as audio data, a phone book) created according to terminal utilization, and so on. Furthermore, the memory 21 may be a high speed random access memory, and may also be a nonvolatile memory such as at least one magnetic disk memory device, a flash memory device or other volatile solid state memory device, for example. Accordingly, the memory 21 may also include a memory controller for providing access of the processor 27 and the input unit 22 to the memory 21.

The input unit 22 may be used to receive digital information or character information that is input, and generate signal inputs by a keyboard, a mouse, a joystick or a trackball, which relate to user settings and function control. Specifically, in an embodiment, the input unit 22 may include a touch-sensitive surface 221 and other input devices 222. The touch-sensitive surface 221, also referred to as a touch display screen or a touch panel, may collect touch operations operated by the user thereon or in the vicinity thereof, such as operations made by the user using any suitable object or accessory (such as a finger, a touch pen) on the touch-sensitive surface 221 or in the vicinity of the touch-sensitive surface 221; and then may drive a corresponding connection device according to a program set in advance. Optionally, the touch-sensitive surface 221 may include a touch detection device and a touch controller. Specifically, the touch detection device detects the touch position of the user and a signal caused by the touch operation, and sends the signal to the touch controller. The touch controller receives the touch information from the touch detection device, converts the information into contact coordinates, then sends the coordinates of the touch point to the processor 27, and receives a command sent from the processor 27 to perform. Furthermore, the touch-sensitive surface 221 may be realized in multiple types such as in resistive type, in capacitive type, in infrared type and in surface acoustic wave type. In addition to the touch-sensitive surface 221, the input unit 22 may also include other input devices 222. Specifically, the other input devices 222 may include but not limited to one or more of a physical keyboard, a function key (such as a volume control button, and a switch button), a trackball, a mouse, a joystick and so on.

The display unit 23 may be used to display information input by the user, information provided to the user and various graphic user interfaces of the terminal Those graphic user interfaces may include a graphic, a text, an icon, a video and any other combination thereof. The display unit 23 may include a display panel 231. Optionally, the display panel 231 may be configured as for example a Liquid Crystal Display (LCD) or an Organic Light-Emitting Diode (OLED) display. Furthermore, the touch-sensitive surface 221 may cover the display panel 231. When the touch-sensitive surface 221 detects a touch operation thereon or in the vicinity thereof, the touch-sensitive surface 221 sends the detected touch operation to the processor 27 to determine a type of the touch event. The processor 27 then provides a corresponding visual output on the display panel 231 according to the type of the touch event. The touch-sensitive surface 221 and the display panel 231, which is shown as two separate components to realize the input function and the output function respectively described with respect to FIG. 5, may be integrated together to realize the input function and the output function in some embodiments.

The terminal may further include at least one sensor 24 such as a light sensor, a motion sensor and other sensors. Specifically, the light sensor may include an ambient light sensor and a proximity sensor. The ambient light sensor may adjust a brightness of the display panel 231 according to ambient light. The proximity sensor may turn off the display panel 231 and/or a backlight when the terminal is closed to the user's ear. As one of the motion sensors, a gravity acceleration sensor may detect an acceleration value in each direction (generally, in three axial directions), and detect a value and a direction of the gravity in a stationary state. The gravity acceleration sensor may be applied to an application (such as orientation change, related games, magnetometer attitude calibration) for identifying the attitude of a cell phone, a function related to vibration identification (such as a pedometer, or a knock) and so on. Other sensors such as a gyroscope, a barometer, a hygrometer, a thermometer, an infrared sensor, which may be equipped to the terminal, will not be described here any more.

An audio interface between the user and the terminal may be provided by the audio circuit 25, a speaker 161 and a microphone 162. The audio circuit 25 may convert the received audio data into an electrical signal and transmit the electrical signal to the speaker 161, and the speaker 161 converts the electrical signal into a sound signal to output. On the other hand, the microphone 162 converts the collected sound signal into an electrical signal and sends the electrical signal to the audio circuit 25, and the audio circuit 25 converts the received electrical signal into audio data and outputs the audio data to the processor 27 to process. The processed audio data is then sent to for example another terminal via the RF circuit 20 or output to the memory 21 to further process. The audio circuit 25 may also include an earphone jack to provide communication between a peripheral headphone and the terminal

The WiFi is a short range wireless transmission technology. The terminal may assist the user to send and receive e-mails, browse a webpage and access a streaming media and so on via the WiFi module 26. The WiFi module 26 provides a wireless broadband internet access to the user. Although the WiFi module 26 is illustrated in FIG. 7, it may be understood that the WiFi module 26 is not necessary in the terminal, and can be omitted without changing the scope of essence of the present disclosure.

The processor 27, as a control center of the terminal, is adapted to connect each part of the terminal using various interfaces and lines, and performs various functions of the terminal and data processing by running or executing the software program and/or the software module stored in the memory 21 and calling data stored in the memory 21, thus achieving the monitor of the whole terminal Optionally, the processor 27 may include one or more processing cores. Preferably, an application processor and a modem processor may be integrated into the processor 27. In the process 27, the application processor mainly processes the operating system, user interfaces, applications and so on; and the modem processor mainly processes wireless communication. It may be understood that the modem processor described above may not be integrated into the processor 27.

The terminal may further include the power supply 28 (e.g. a battery) for supplying power to each component. Preferably, the power source may be logically connected to the processor 27 via a power supply management system, thus achieving functions such as charge management, discharge management, power consumption management by the power supply management system. The power supply 28 may further include any components, such as one or more DC power supplies or AC power supplies, a recharge system, a power supply fault detection system, a power supply converter or inverter, or a power supply state indicator.

Although not illustrated, the terminal may also include a camera, a Bluetooth module and so on, which are not described here any more. In this embodiment, the processor 27 in the terminal will perform one or more applications stored in the memory 21 according to the following instructions to realize various functions. The instructions may include the following steps:

acquiring a process startup procedure beginning time of an application in the case that a process of the application is started.

determining a time of when the process of the application is ready or able to respond to user input, where the time of when the process of the application is ready or able to respond to user input may be used as a process startup procedure ending time for the process of the application; and

determining a startup period for the process of the application according the process startup procedure beginning time and the process startup procedure ending time to determine a startup performance measurement for the process of the application.

Furthermore, in a case where the application is a CUI application, in the step of determining the time of when the process of the application is ready or able to respond to user input, the processor 27 may call a WaitForIdleInput interface to determine whether the process of the application can respond to user input, and may record a time of when the WaitForIdleInput interface provides a return value as the time of when the process of the application is ready or able to respond to user input. In instances when the WaitForIdleInput interface does not provide the return value within a first timeout period, the processor 27 may stop the step of determining the time of when the process of the application is ready or able to respond to user input.

On the other hand, in a case where the application is a GUI application, in the step of determining the time of when the process of the application is ready or able to respond to user input, the processor 27 may monitor whether a user interactive main window corresponding to the application is opened. In a case that the user interactive main window corresponding to the application is open, a message may be sent to the user interactive main window. The response time of the user interactive main window may be utilized as the time of when the process of the application is ready or able to respond to user input. When the user interactive main window does not respond to the message within a second timeout period, the processor 27 may stop the step of determining the time of when the process of the application is ready or able to respond to user input.

Specifically, in the step of monitoring whether the user interactive main window corresponding to the application is opened, the processor 27 may call a message monitoring interface or an event monitoring interface to wait for a notification of a message or event of the application. When the message monitoring interface or the event monitoring interface has received a notification of a message or event of the application, the processor 27 may determine whether the message or the event is a displaying message or a displaying event of the user interactive main window. In instances when the message or the event is the displaying message or the displaying event of the user interactive main window, the user interactive main window corresponding to the application may be open.

Those skilled in the art should understand that all or a part of steps in various methods in the embodiments described above can be implemented by instructing related hardware using a program. The program may be stored in a non-transitory computer readable storage medium. The storage medium may include a Read-Only Memory (ROM), a Random Access Memory (RAM), a magnetic disk, an optical disk or the like.

Hereinbefore, the method for determining the performance of the process of the application and the computer system are introduced in detail above according to the embodiments of the present disclosure. The principle and the embodiments of the present disclosure have been illustrated by specific examples used herein, and the above description of the embodiments is used to assist with understanding the method and the core concept of the present disclosure. Meanwhile, those skilled in the art may make some variations in the embodiments according to concepts of the present disclosure. In summary, the embodiments of this description should not be interpreted as limiting the disclosure.

1. A method for determining performance of a process of an application, the method comprising:
acquiring a process startup beginning time for the process of the application when the process of the application is started;
determining a time of when the process of the application is ready or able to respond to user input and utilizing said time as a process startup ending time for the process of the application; and
determining a process startup period for the process of the application based on the process startup beginning time and the time of when the process is able to respond to user input as the process startup ending time, to determine the startup performance of the process of the application.

2. The method according to claim 1 wherein the application is a command-line user interface (CUI) application, and the determining a time of when the process of the application is ready or able to respond to user input comprises:
calling a WaitForIdleInput interface to determine whether the process of the application is ready or able to respond to user input;
acquiring a time of when the WaitForIdleInput interface provides a return value in instances when the WaitForIdleInput interface provides a return value; and
utilizing the time of when the WaitForIdleInput interface provides the return value as the time of when the process of the application is ready or able to respond to user input.

3. The method according to claim 2 wherein, in instances when the WaitForIdleInput interface does not provide the return value within a first timeout period, stopping the determining a time of when the process of the application is ready or able to respond to user input.

4. The method according to claim 1 wherein the application is a graphical user interface (GUI) application and the determining a time of when the process of the application is ready or able to respond to user input comprises:
monitoring whether a user interactive main window that corresponds to the application is open;
sending a message to the user interactive main window that corresponds to the application, in instances when the user interactive main window that corresponds to the application is open; and
utilize a response time of the user interactive main window that corresponds to the application, as the time when the process of the application is ready or able to respond to user input.

5. The method according to claim 4, wherein the monitoring of whether the user interactive main window that corresponds to the application is open comprises:
calling a message monitoring interface to wait for a notification of a message from the application, or calling an event monitoring interface to wait for a notification of an event of the application; and
in instances when the message monitoring interface receives the notification of the message from the application or in instances when the event monitoring interface receives the notification of the event of the application, determining whether the message is a displaying message for the user interactive main window or whether the event is a displaying event of the user interactive main window; and
monitoring whether the user interactive main window that corresponds to the application is open.

6. The method according to claim 4 wherein, when the user interactive main window does not respond to the message within a second timeout period, stopping the determining the time of when the process of the application is ready or able to respond to user input.

7. The method according to claim 5 wherein, when the user interactive main window does not respond to the message within a second timeout period, stopping the determining the time of when the process of the application is ready or able to respond to user input.

8. A computer system for determining performance of a process of an application, the computer system comprising one or more hardware processors or circuits that are operable to:
in a process startup unit, start a process of an application;
in a startup time acquiring unit, acquire a process startup beginning time of the process of the application when the process of the application is started by the process startup unit;
in a response time determining unit, determine a time of when the process of the application is ready or able to respond to user input and utilizing said time of when the process of the application is ready or able to respond to user input as a process startup ending time for the process of application; and
in a performance determining unit, determine a process startup period for the process of the application based on the process startup beginning time and the process startup ending time, to determine the startup performance of the process of the application.

9. The computer system according to claim 8, wherein the application is a command-line user interface (CUI) application and the one or more hardware processors or circuits are operable to:
in an input calling unit of the response time determining unit, call a WaitForIdleInput interface to determine whether the process of the application is ready or able to respond to user input;
in a first time determining unit of the response time determining unit, acquire a time of when the WaitForIdleInput interface provides a return value in instances when the WaitForIdleInput interface provides a return value; and
utilize the time of when the WaitForIdleInput interface provides the return value as the time of when the process of the application is ready or able to respond to user input.

10. The computer system according to claim 9, wherein the one or more hardware processors or circuits are operable to:
in a first stopping unit, when the WaitForIdleInput interface does not provide the return value within a first timeout period, notify the response time determining unit to stop determining the time when the process of the application is ready or able to respond to user input.

11. The computer system according to claim 8, wherein the application is a GUI application and the one or more hardware processors or circuits are operable to:
in a monitoring unit of the response time determining unit, monitor whether a user interactive main window that corresponds to the application is open;
in a message sending unit of the response time determining unit, send a message to the user interactive main window that corresponds to the application, in instances when the user interactive main window that corresponds to the application is open; and
in a second time determining unit of the response time determining unit, utilize a response time of the user interactive main window that corresponds to the application, as the time when the process of the application is ready or able to respond to user input.

12. The computer system according to claim 11, wherein the one or more hardware processors or circuits are operable to:
in the monitoring unit, call a message monitoring interface to wait for a notification of a message from the application, or call an event monitoring interface to wait for a notification of an event of the application; and
in instances when the message monitoring interface receives the notification of the message from the application or when the event monitoring interface receives the notification of the event of the application:
determine whether the message is a displaying message for the user interactive main window or whether the event is a displaying event of the user interactive main window; and
monitor whether the user interactive main window corresponding to the application is open.

13. The computer system according to claim 11, wherein the one or more processors or circuits are operable to:
in a second stopping unit, when the user interactive main window does not respond to the message within a second timeout period, stop determining the time of when the process of the application is ready or able to respond to user input.

14. The computer system according to claim 12, wherein the one or more processors or circuits are operable to:
in a second stopping unit, when the user interactive main window does not respond to the message within a second timeout period, stop determining the time of when the process of the application is ready or able to respond to user input.

15. A non-transitory machine-readable medium having stored thereon, a computer program having at least one code section for determining performance of a process of an application, the at least one code section being executable by a machine for causing the machine to perform steps comprising:
acquiring a process startup beginning time for the process of the application when the process of the application is started;
determining a time of when the process of the application is ready or able to respond to user input and utilizing said time of when the process is ready or able to respond to user input as a process startup ending time for the process of the application; and
determining a process startup period for the process of the application based on the process startup beginning time and the time of when the process is able to respond to user input as the process startup ending time, to determine the startup performance of the process of the application.

16. The non-transitory machine-readable medium of claim 16 wherein the application is a command-line user interface (CUI) application and the determining a time of when the process of the application is ready or able to respond to user input comprises:
calling a WaitForIdleInput interface to determine whether the process of the application is ready or able to respond to user input;
acquiring a time of when the WaitForIdleInput interface provides a return value in instances when the WaitForIdleInput interface provides a return value; and
utilizing the time of when the WaitForIdleInput interface provides the return value as the time of when the process of the application is ready or able to respond to user input.

17. The non-transitory machine-readable medium of claim 15 wherein, when the WaitForIdleInput interface does not provide the return value within a first timeout period, stopping the determining a time of when the process of the application is ready or able to respond to user input.

18. The non-transitory machine-readable medium of claim 15, wherein the application is a graphical user interface (GUI) application and the determining a time of when the process of the application is ready or able to respond to user input comprises:
monitoring whether a user interactive main window that corresponds to the application is open;
sending a message to the user interactive main window that corresponds to the application, in instances when the user interactive main window that corresponds to the application is open; and
utilize a response time of the user interactive main window that corresponds to the application, as the time when the process of the application is ready or able to respond to user input.

19. The non-transitory machine-readable medium of claim 18, wherein the monitoring of whether the user interactive main window that corresponds to the application is open comprises:
calling a message monitoring interface to wait for a notification of a message from the application, or calling an event monitoring interface to wait for a notification of an event of the application; and
in instances when the message monitoring interface receives the notification of the message from the application or in instances when the event monitoring interface receives the notification of the event of the application, determining whether the message is a displaying message for the user interactive main window or whether the event is a displaying event of the user interactive main window; and
monitoring whether the user interactive main window that corresponds to the application is open.

20. The non-transitory machine-readable medium of claim 19 wherein, when the user interactive main window does not respond to the message within a second timeout period, stopping the determining the time of when the process of the application is ready or able to respond to user input.
